(19) United States
(12) Patent Application Publication
(10) Pub. No.: US 2011/0157727 A1
(43) Pub. Date: Jun. 30, 2011

(54) COVER MEMBER, LENS UNIT AND PRODUCTION METHOD

(75) Inventors: Naoki SASAKI, Saitama (JP); Ryota SASAKI, Saitama (JP); Eiichi KABE, Saitama (JP)

(73) Assignee: FUJIFILM CORPORATION, Tokyo (JP)

(21) Appl. No.: 12/956,215

(22) Filed: Nov. 30, 2010

(30) Foreign Application Priority Data
Dec. 28, 2009 (JP) 2009-297586

(51) Int. Cl. G02B 7/02; B05D 1/18

(52) U.S. Cl. 359/808; 427/430.1

(57) ABSTRACT

A cover member disposed in front of a lens includes a central section and a peripheral section. The peripheral section surrounds the central section and has a step bordering the central section. A part of the central section on a side bordering on the peripheral section is formed to be an inclined surface. Each of a starting point and an end point of the inclined surface is formed to be a curved surface. The cover member has a coated surface.

### BACKGROUND OF THE INVENTION

1. Field of the Invention

The present invention relates to a cover member, a lens unit having the cover member, and a method of producing the cover member.

2. Description of the Related Art

As an example of a lens unit, a camera module in which a lens and an imaging device are incorporated is known (see, for example, Japanese Patent Application Publication No. 2005-79931). The camera module includes the lens provided in front of the imaging device that takes an image, and further includes a transparent cover disposed in front of the lens, depending on use for a lens module such as a vehicle-mounted lens module. As the lens and the cover in the lens unit represented by such a camera module, those made of resin are widely used instead of those made of glass due to easy production.

FIG. 1 is a perspective diagram that illustrates an example of the lens unit. FIG. 1 illustrates a state in which the lens unit is partially removed for easy understanding of an internal structure of the lens unit.

A lens unit 10 illustrated in FIG. 1 includes: an imaging device 12 attached to a circuit board 11, three lenses 13 that form an image on the imaging device 12 based on subject light, a lens support member 14 that supports the lenses 13, a base member 15 that is fixed to the circuit board 11 and surrounds the imaging device 12 and the lens support member 14, and a disc-shaped cover member 20 that protects the lenses, and a unit case 17.

The three lenses 13 are disposed in front of the imaging device 12, namely, on the subject side, and the cover member 20 is disposed in front of the lenses 13. The lenses 13 and the cover member 20 are formed by a transparent resin material. The unit case 17 is approximately shaped like a hexahedron, and the circuit board 11, the imaging device 12, the lenses 13, the lens support member 14, the base member 15 and the cover member 20 are built in the unit case 17. However, the cover member 20 is attached to internally close an aperture 17a provided in a front surface of the unit case 17, and a central portion of the cover member 20 is exposed outside. Further, between the cover member 20 and the unit case 17, an O-ring 18 is interposed to protect the lens unit 10 from water and dust.

The cover member 20 is a component exposed outside in place of the lenses 13 and thus, scratch-resistant performance and crack-resistant performance against friction and collisions caused by external foreign objects are desired to be improved. Here, it is known that a lens is soaked in a coating material in liquid form and then raised from the coating material so that a hard coat is applied to a lens surface (for example, Japanese Patent Application Publications No. 2000-189884 and No. 2000-210614).

FIG. 2A and FIG. 2B are diagrams that illustrate a conventional cover member provided in the lens unit illustrated in FIG. 1. FIG. 2A is a front view of the cover member 20, and FIG. 2B is a diagram that illustrates a longitudinal section of a middle part of the cover member 20.

The cover member 20 illustrated in FIG. 2A and FIG. 2B includes a central section 211 that transmits light of forming an image on the imaging device 12 and a peripheral section 212 that surrounds the central section 211. The central section 211 and the peripheral section 212 are integrally molded by a transparent resin material. Between the central section 211 and the peripheral section 212, a step 212a is formed. By abutment of the step 212a of the cover member 20 on an edge of the aperture 17a of the unit case 17 (see FIG. 1), a position relative to the unit case 17 is determined, and a displacement of the cover member 20 is prevented.

Here, when coating is applied to the cover member in the shape of having the step as illustrated in FIG. 2A and FIG. 2B, there is a possibility that a liquid pool as indicated by a reference character 22a in FIG. 2A and FIG. 2B is produced. Incidentally, in the cross-sectional view in FIG. 2B, the thickness of a coating material 22 is enlarged so that the shape of the coating material 22 on a front surface of the central section 211 is easy to see.

In other words, suppose a cover member base 21 is soaked in the coating material in liquid form and then raised from the coating material, there is a possibility that the coating material streaming down a surface of the cover member base 21 is accumulated at an upper part of a corner of the step 212a and thereby causes the liquid pool 22a, so that in the thickness of the coating material in the central section 211, a part where the liquid pool 22a is formed is thicker than the remaining part. In this case, when the light to form an image on the imaging device 12 passes through the part where the liquid pool 22a is formed, the direction of the light is disturbed and thereby a distortion occurs in the formed image.

### SUMMARY OF THE INVENTION

It is an object of the present invention to address the above problem and provide a cover member in which a disturbance of passing light is suppressed, a lens unit which includes the cover member, and a method of producing the cover member.

According to a first aspect of the invention, a cover member to be disposed in front of an optical component includes:
a central section; and
a peripheral section that surrounds the central section while having a step bordering the central section, wherein
a part of the central section on a side bordering on the peripheral section is formed to be an inclined surface, and each of a starting point and an endpoint of the inclined surface is formed to be a curved surface, and the cover member has a coated surface.

In the cover member of the present invention, the part of the central section on the side bordering on the peripheral section is formed to be an inclined surface, and each of the starting point and the endpoint of this inclined surface is formed to be a curved surface. Therefore, when the cover member is formed, the cover member is soaked in the coating material in the posture in which the inclined surface is below the central section and raised, the coating material streaming down the central section runs further downward after streaming down the inclined surface. For this reason, a liquid pool is not formed on the central section and thus, the thickness of the coating material in the central section of the cover member becomes uniform in thickness. Therefore, a disturbance of light passing through the central section is suppressed.

It is preferable that the cover member further includes a marking for recognizing a position of the inclined surface

When the cover member is attached to the lens unit, the inclined surface of the cover member and its vicinity may be reliably deviated from the area through which the light to form an image on the imaging device passes, by using the marking as a target.

In addition, According to a second aspect of the invention, lens unit includes:
an image forming lens that forms an image based on subject light; and
a cover member disposed in front of the image forming lens, wherein
the cover member includes:
   a central section; and
   a peripheral section that surrounds the central section while having a step bordering the central section, wherein
   a part of the central section on a side bordering on the peripheral section is formed to be an inclined surface, and each of a starting point and an end point of the inclined surface is formed to be a curved surface, and
      the cover member has a coated surface.

According to the lens unit of the present invention, a disturbance of the light passing through the cover member is suppressed, and a distortion of the image is suppressed.

According to a third aspect of the invention, a production method of a cover member to be disposed in front of an optical component includes:
forming a cover member base that has a central section and a peripheral section that surrounds the central section while having a step bordering the central section, in which a part of the central section on a side bordering on the peripheral section is formed to be an inclined surface, and each of a starting point and an end point of the inclined surface is formed to be a curved surface; and
   coating the cover member base with a film-shaped coating material, by soaking the cover member base in a posture in which the inclined surface is directed downward in the coating material in liquid form, and raising the cover member base from the coating material thereby making the coating material adhering to the cover member base solidify.

It is possible to produce the cover member in which a disturbance of the light passing through the central section is suppressed.

In the production method, it is preferable that the forming the over member base is forming the over member base that further includes, in addition to the central section, the peripheral section and the inclined surface, a coating-material pool section which is disposed at a position lower than the inclined surface across the peripheral section when the inclined surface is directed downward, and which guides the coating material streaming down the inclined surface and the peripheral section further downward thereby accumulating the coating material, and the production method further comprises the removing the coating-material pool section after the coating.

In the coating, when the cover member base is soaked in the coating material and then raised, the coating material streaming down the inclined surface and running further downward is led to the coating-material pool section so that a liquid pool is formed further away from the central section. The thickness including the coating material in the central section becomes more uniform. Therefore, the disturbance of the light passing through the central section is further suppressed. In addition, the coating-material pool section does not remain in the completed cover member.

In addition, according to a mode of the production method of the present invention, the removing is removing the coating-material pool section while leaving a piece of the coating-material pool section on the cover member base, thereby forming a marking formed by the piece and used to recognize the inclined surface.

By using the piece remaining after the removal as the marking, the marking for reliably deviating the inclined surface of the cover member and its vicinity from the area through which the light to form an image on the imaging device passes may be formed only by removing the coating-material pool section. Therefore, the production process is simplified.

As described above, according to the present invention, there are realized the cover member in which the disturbance of the passing light is suppressed, the lens unit including the cover member, and the method of producing the cover member.

### BRIEF DESCRIPTION OF THE DRAWINGS

FIG. 1 is a perspective diagram that illustrates an example of the lens unit;

FIG. 2A and FIG. 2B are diagrams that illustrate a conventional cover member provided in the lens unit illustrated in FIG. 1;

FIG. 3A and FIG. 3B are external views of a first embodiment of the cover member according to the present invention;

FIG. 4 is an enlarged diagram that illustrates a longitudinal section of a lower part of the cover member illustrated in FIG. 3A and FIG. 3B;

FIG. 5 is a diagram for explaining the method of producing the cover member illustrated in FIG. 3A and FIG. 3B;

FIG. 6 is a diagram that illustrates the cover member in a state after being raised from the coating material;

FIG. 7 is a diagram that illustrates a positional relationship between the cover member in a state of being attached to the unit case and the O-ring;

FIG. 8 is a diagram that illustrates a modification in which both the front and back surfaces of the cover member base are coated;

FIG. 9A is an external view of the second embodiment of the cover member according to the present invention;

FIG. 9B is a diagram that illustrates a longitudinal section of a middle part of the cover member 40; and

FIG. 10 is a diagram for explaining a method of producing the cover member illustrated in FIG. 9A and FIG. 9B.

### DETAILED DESCRIPTION OF THE INVENTION

Exemplary embodiments of the present invention will be described below with reference to the drawings.

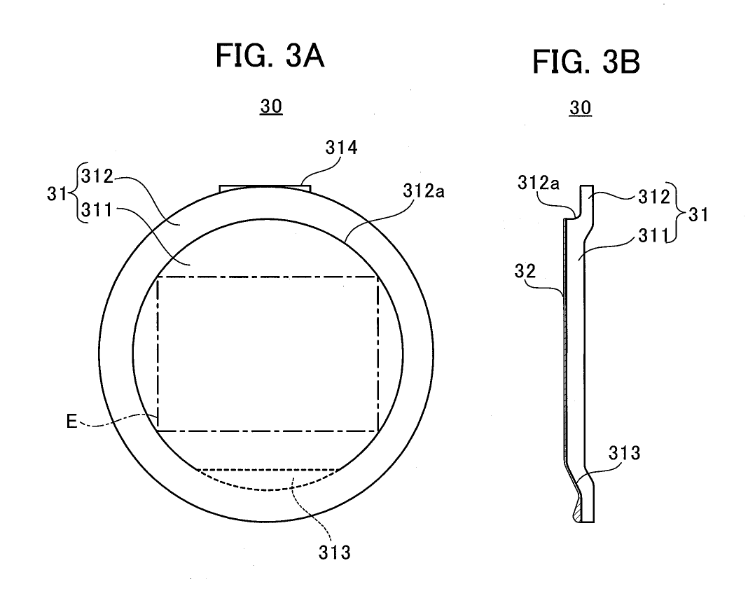

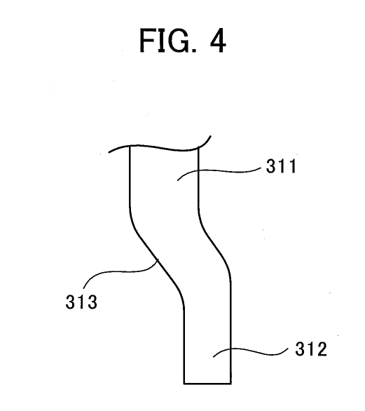

FIG. 3A and FIG. 3B are external views of a first embodiment of the cover member according to the present invention. FIG. 3A is a front view of a cover member 30, and FIG. 3B is a diagram that illustrates a longitudinal section of a middle part of the cover member 30. Further, FIG. 4 is an enlarged diagram that illustrates a longitudinal section of a lower part of the cover member illustrated in FIG. 3A and FIG. 3B.

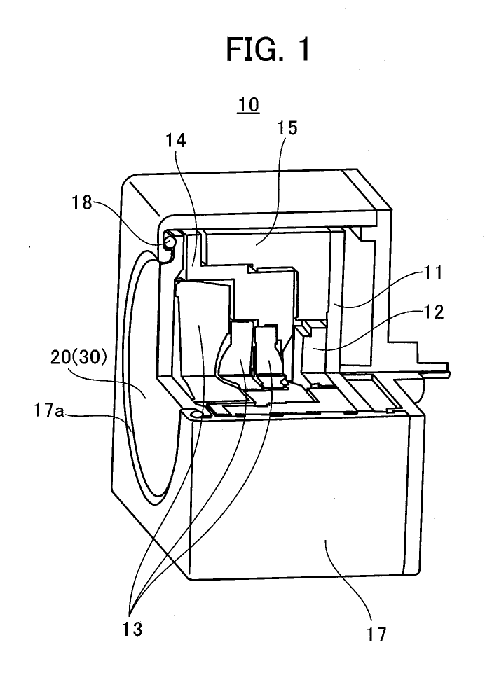

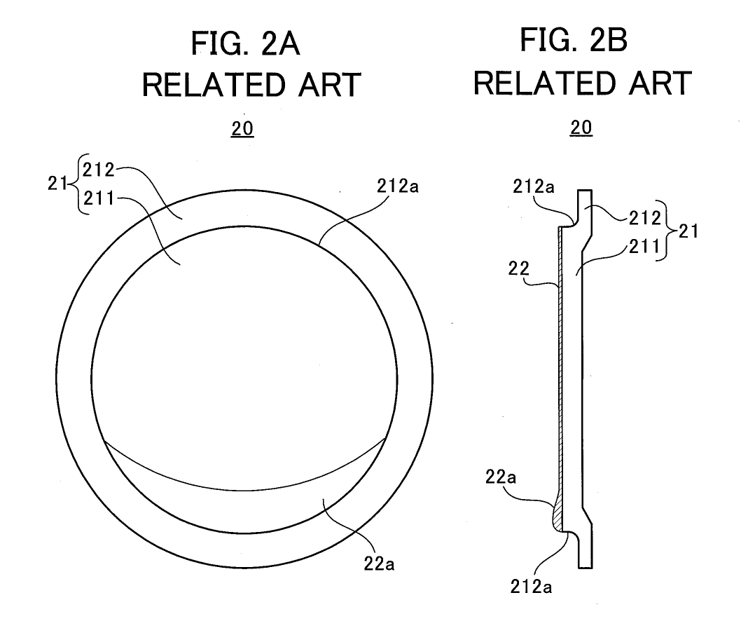

The cover member 30 illustrated in FIG. 3A and FIG. 3B is a member to be attached in place of the cover member 20 of the lens unit 10 illustrated in FIG. 1. The lens unit 10, which includes the cover member 30 of the present embodiment in place of the cover member 20, is one embodiment of the lens unit according to the present invention. The structure of the lens unit 10 that is the embodiment of the present invention is the same as the structure already described with reference to FIG. 1 except the cover member 30 and therefore, FIG. 1 is used and overlapping description will be omitted.

The cover member 30 illustrated in FIG. 3A and FIG. 3B is a member in which a front surface of a disc-shaped cover member base 31 is coated with a coating material 32. The cover member base 31 includes: a central section 311 that transmits light passing through the lenses 13 (see FIG. 1) to form an image on the imaging device; and a peripheral section 312 that surrounds the central section 311. The central section 311 has a uniform thickness not to allow deterioration of the image formed by the passing light. The central section 311 and the peripheral section 312 are integrally molded by a transparent resin material. Of the central section 311, on a part of a border with the peripheral section 312, a step 312a is formed. However, of the central section 311, a part of the remaining part of the border with the peripheral section 312 is formed to be an inclined surface 313. Further, in the cover member base 31, a marking protrusion 314 that protrudes from a part of the peripheral section 312 is provided. The marking protrusion 314 is to allow recognition of a position of the inclined surface 313 in the cover member 30, and is disposed opposite the inclined surface 313 across the central section 311. This marking protrusion 314 is equivalent to an example of the marking according to the present invention.

The inclined surface 313 is formed to make a slope astride both of the central section 311 and the peripheral section 312 in between. To be more specific, as more clearly illustrated in FIG. 4, the inclined surface 313 extends from a flat part of the central section 311 after curving at an obtuse angle, and also extends from the peripheral section 312 after curving at an obtuse angle. In other words, an obtuse angle is formed between the inclined surface 313 and a surface of the flat part of the central section 311 and also, an obtuse angle is formed between the inclined surface 313 and a surface of the peripheral section 312. Further, each of a boundary part between the flat part of the central section 311 and the inclined surface 313 and a boundary part between the peripheral section 312 and the inclined surface 313, which are a starting point and an endpoint of the inclined surface 313, respectively, is a link formed by a curved surface.

Here, a method of producing the cover member 30 illustrated in FIG. 3A and FIG. 3B will be described.

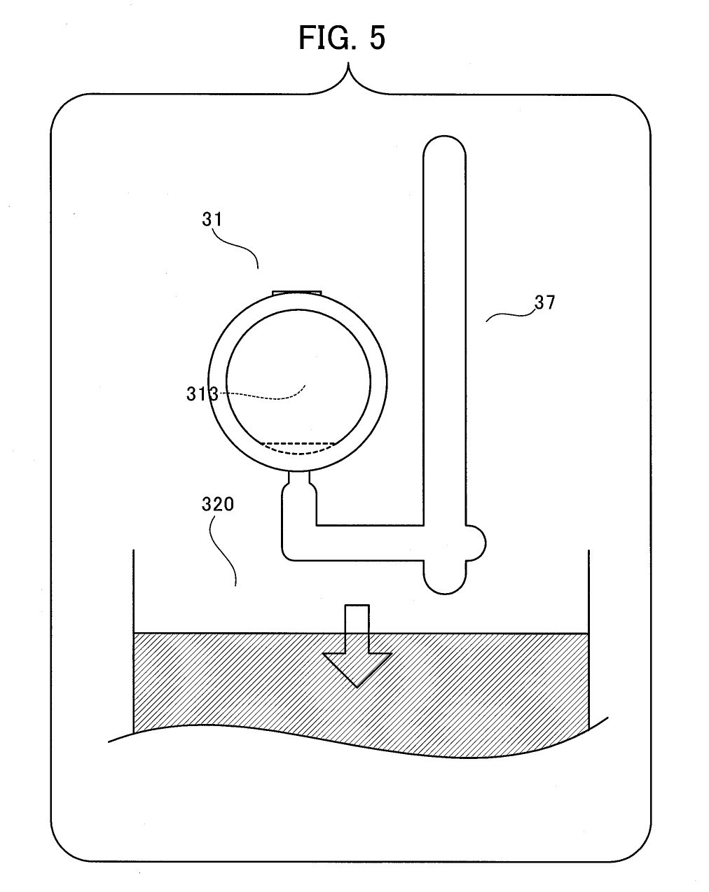

FIG. 5 is a diagram for explaining the method of producing the cover member illustrated in FIG. 3A and FIG. 3B.

To produce the cover member 30, first, the cover member base 31 having the shape described with reference to FIG. 3A and FIG. 3B is formed in a cover-member-base forming process. FIG. 5 illustrates a state in which a runner 37 is connected to the cover member base 31. The cover member base 31 and the runner 37 are integrally molded by a transparent resin.

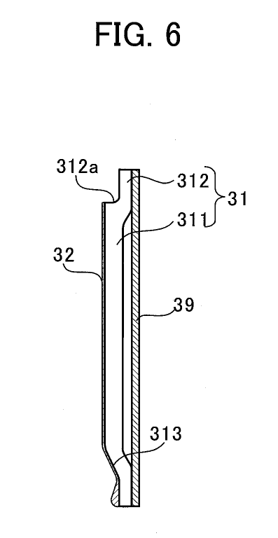

Next, to a rear surface of the cover member base 31, namely, an inner side of the lens unit 10 in a state in which the cover member base 31 is attached to the lens unit 10, a masking member 39 (see FIG. 6) shaped like a film is affixed. Thereby, the coating material does not touch the rear surface of the cover member base 31.

Subsequently, in a coating process, the cover member base 31 is soaked in a coating material 320 in liquid form. In the coating process, the cover member base 31 is handled in a state of being connected to the runner 37. To be more specific, a worker or a device holds the runner 37 and soaks the cover member base 31 in a posture in which the inclined surface 313 is directed downward in the coating material 320. Subsequently, the cover member base 31 is raised from the coating material 320 in liquid form, so that the coating material adhering to the cover member base 31 solidifies.

FIG. 6 is a diagram that illustrates the cover member in a state after being raised from the coating material.

The front surface of the cover member base 31 after being raised from the coating material 320 is covered with the coating material in liquid form. The masking member 39 is affixed to the rear surface of the cover member base 31. The masking member 39 is a member all over which is coated with an adhesive, and the masking member 39 does not peel off the cover member base 31 even when the cover member base 31 is soaked in the coating material 320 (FIG. 5). Thus, the coating material 320 does not adhere to the rear surface of the cover member base 31. To be more specific, the masking member 39 adheres to the peripheral section 312 protruding further backward than the central section 311, and does not contact the central section 311.

It is desirable that the masking member 39 be a material that repels the coating material in liquid form or be coated to repel the coating material. This is because when the coating material in liquid form does not adhere to the masking member 39, the coating material is not wasted.

After being raised from the coating material 320 in liquid form, the cover member base 31 is, as illustrated in FIG. 5, held in the posture in which the inclined surface 313 is directed downward. During a period after the cover member base 31 is raised from the coating material 320 in liquid form until the coating material covering the front of the cover member base 31 solidifies, the coating material gently streams downward due to gravity. If the cover member base is placed in a posture of spreading horizontally, the coating material may solidify in a state of hanging down from a part of the cover member base. By placing the cover member base 31 in a posture of spreading in a vertical direction, the state in which the coating material hangs down from the part of the cover member base is avoided.

Further, in the posture in which the inclined surface 313 is directed downward, the coating material streaming down the surface of the central section 311 of the cover member base 31 heads for the inclined surface 313 and gathers. Here, as illustrated in FIG. 4, the inclined surface 313 is formed to make the slope astride both of the flat part of the central section 311 and the peripheral section 312, and each of apart between the flat part of the central section 311 and the inclined surface 313 and a part between the peripheral section 312 and the inclined surface 313 is the link formed by the curved surface. Therefore, there is no corner to keep the coating material in liquid form. For this reason, the coating material in liquid form, which is heading for the inclined surface 313 and gathering, streams down the inclined surface 313 toward the peripheral section 312 located further downward. Thus, a liquid pool is not formed on the central section 311 of the cover member base 31.

By raising the cover member base 31 from the coating material 320 in liquid form and thereby making the coating material adhering to the cover member base 31 solidify, the cover member base 31 is covered with the solid coating material shaped like a film. Subsequently, when the masking member 39 is peeled off the cover member base 31 and the runner 37 is separated, the cover member 30 illustrated in FIG. 3A and FIG. 3B is completed.

Referring back to FIG. 3A and FIG. 3B again, the description will be provided. When being in liquid form in a production process, the coating material 32 streams down from the central section 311 along the inclined surface 313 and thus, the coating material 32 solidifies in a state in which no liquid pool is formed on the central section 311. For this reason, the coating material 32 formed on the central section 311 has a film thickness uniform to the extent that no distortion of image is caused.

The completed cover member 30 illustrated in FIG. 3A and FIG. 3B is attached to close the aperture 17a of the unit case 17 illustrated in FIG. 1.

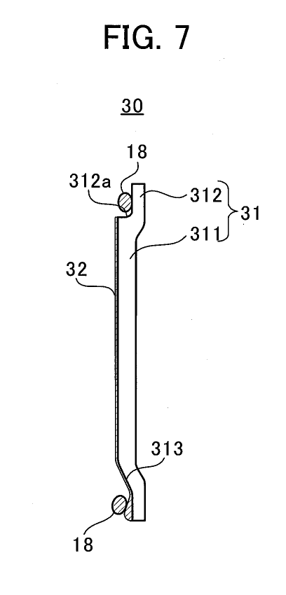

FIG. 7 is a diagram that illustrates a positional relationship between the cover member in a state of being attached to the unit case and the O-ring.

As illustrated in FIG. 7, the O-ring 18 is disposed in a part where the step 312a is formed, between the central section 311 and the peripheral section 312 of the cover member 30.

The description will be continued by returning to FIG. 3A and FIG. 3B. FIG. 3A illustrates, of the cover member 30, an effective image range E through which the light transmitting the lenses 13 (see FIG. 1) to form an image on the imaging device 12 passes. The effective image range E is approximately rectangular according to the shape of the imaging device 12, and is arranged to spread up to the border between the central section 311 and the peripheral section 312. The inclined surface 313 is arranged further inward than a circle of the border between the central section 311 and the peripheral section 312 and thus, there is a possibility that corners of the effective image range E overlap the inclined surface 313, depending on the posture of the cover member 30 attached to the unit case 17. In the cover member 30 of the present embodiment, the marking protrusion 314 to allow recognition of the position of the inclined surface 313 of the cover member 30 is formed. Therefore, when the cover member 30 is attached to the unit case 17, by using the marking protrusion 314 as a mark, the cover member 30 is attached in the posture in which the inclined surface 313 is located below the central section 311 as illustrated in FIG. 3A and FIG. 3B or on the contrary, the cover member 30 is attached in a posture in which the inclined surface 313 is located above the central section 311. This avoids the situation in which the corners of the effective image range E overlap the inclined surface 313.

According to the lens unit 10 of the present embodiment including the cover member 30 of the present embodiment, the effective image range E is provided on apart where the coating material is uniform in thickness and thus, a disturbance of the light passing through the cover member 30 is suppressed, and a distortion of an image formed on the imaging device 12 by the lenses 13 is suppressed.

The embodiment has been described by using the example in which the rear surface of the cover member base 31 is not coated with the masking member 39. However, here, as the structure of the cover member, a structure in which both the front and back surfaces of the cover member base are coated may be adopted.

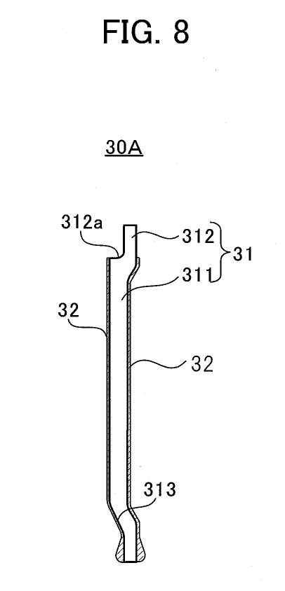

FIG. 8 is a diagram that illustrates a modification in which both the front and back surfaces of the cover member base are coated.

A cover member 30A illustrated in FIG. 8 is produced by soaking the cover member base 31 in the coating material 320, without affixing a masking member to the cover member base 31 in the coating process. Therefore, both the front and back surfaces of the cover member base 31 are coated with the coating material 32. As for other features, the cover member 30A is the same as the cover member 30 illustrated in FIG. 3A and FIG. 3B, and the parts in the figure, which correspond to those of the cover member 30, are indicated by the same reference characters.

Next, a second embodiment of the present invention will be described. In the following description of the second embodiment, the same elements as those of the first embodiment are indicated by the same reference characters as those of the first embodiment, and a feature different from the first embodiment will be described.

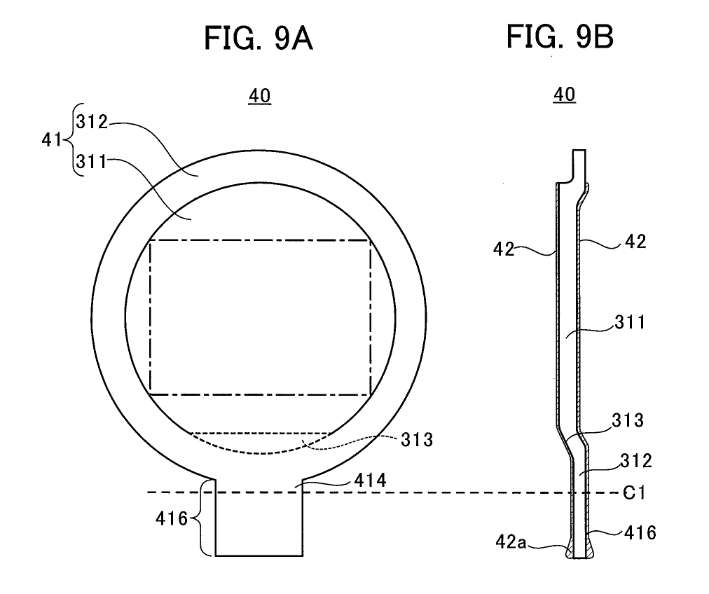

FIG. 9A is an external view of the second embodiment of the cover member according to the present invention. FIG. 9A is a front view of a cover member 40, and FIG. 9B is a diagram that illustrates a longitudinal section of a middle part of the cover member 40.

As compared with the cover member 30 of the first embodiment illustrated in FIG. 3A and FIG. 3B, the cover member 40 illustrated in FIG. 9A and FIG. 9B is different in that a cover member base 41 does not have the marking protrusion 314 and in that the cover member base 41 has a marking protrusion 414 that protrudes from a part of the edge of the peripheral section 312. The marking protrusion 414 is located at a position opposite to the marking protrusion 314, namely, a position lower than the inclined surface 313 across the peripheral section 312, when the inclined surface 313 is directed downward. The marking protrusion 414 is formed by a piece that remains as a result of cutting a liquid pool section 416 formed at the cover member base 41 along a removing line C1 at a midpoint of the liquid pool section 416. The liquid pool section 416 is eventually removed in a production process of the cover member 40. FIG. 9A and FIG. 9B illustrate a state before the liquid pool section 416 is removed, namely, a shape of the cover member 40 immediately before completion. Here, the marking protrusion 414 is equivalent to an example of the marking according to the present invention.

The liquid pool section 416 is located, when the inclined surface 313 is directed downward, at a position lower than the inclined surface 313 across the peripheral section 312, and protrudes from the part of the edge of the peripheral section 312. The liquid pool section 416 has the same thickness as that of the peripheral section 312.

To produce the cover member 40 illustrated in FIG. 9A and FIG. 9B, first, the cover member base 41 is formed in a cover-member-base forming process.

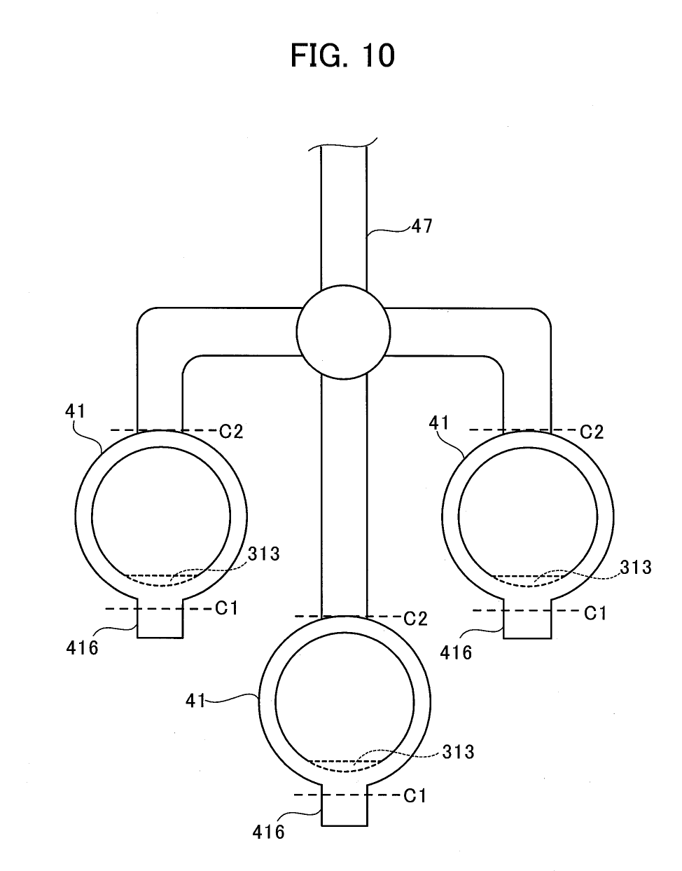

FIG. 10 is a diagram for explaining a method of producing the cover member illustrated in FIG. 9A and FIG. 9B.

FIG. 10 illustrates a state in which three cover member bases 41 are connected to a runner 47. The cover member bases 41 and the runner 47 are integrally molded by a transparent resin. Thereby, plural cover members 40 may be produced at a time.

Next, in a coating process, the cover member bases 41 are soaked in a coating material in liquid form. In the coating process, the runner 47 is handled in a state of being connected to the cover member bases 41. To be more specific, a worker or a device holds the runner 47 and soaks the cover member bases 41 in a posture, in which the inclined surfaces 313 are directed downward, in the coating material. Subsequently, the cover member base 41 is raised from the coating material in liquid form so that the coating material solidifies.

During a period after the cover member base 41 is raised from the coating material in liquid form until the coating material solidifies, the coating material gently flows downward due to gravity. The coating material in liquid form, which heads for the inclined surface 313 from the flat part of the central section 311 and gathers, streams down the inclined surface 313 and is led to the liquid pool section 416 located further below. Therefore, as illustrated in FIG. 9B, a liquid pool 42a is formed on the liquid pool section 416, to be further away from the central section 311 of the cover member base 31. Therefore, the thickness of the coating material in the central section 311 becomes more uniform.

Subsequently, in a removing process, the liquid pool section 416 is cut along the removing line C1 at the midpoint, so that the liquid pool section 416 is removed from the cover member base 41. Further, by cutting along a removing line C2 (see FIG. 10), the cover member base 41 is separated from the runner 47. As a result, the cover member 40 of the second embodiment is completed. Removal of the liquid pool section 416 results in a state in which the liquid pool 42a of the coating material does not remain in the cover member 40. Further, by leaving the piece in the cover member base 41 when removing the liquid pool section 416, the marking protrusion 414 (see FIG. 9A) is formed and thus, the marking protrusion 414 may be formed only by removing the liquid pool section 416, so that the production process is simplified.

Incidentally, in the above description of the embodiments, the lens unit including the imaging device has been described as an example of the lens unit according to the present invention. However, the lens unit according to the present invention is not limited to this example and may be, for example, one of a type with no built-in imaging device and to be attached later.

In the above description of the embodiments, the lens unit including the three lenses 13 has been described as an example of the lens unit according to the present invention. However, the lens unit according to the present invention is not limited to this example and may be a lens unit with one lens or two lenses or a lens unit with four or more lenses.

In the above description of the embodiments, the formation of the member in which one or three cover member bases are connected to the runner has been described as example of the cover-member-base forming process according to the present invention. However, the present invention is not limited to this example, and the number of the cover member bases connected to the runner may be two, or four or more.

What is claimed is:

1. A cover member to be disposed in front of an optical component, the cover member comprising:
a central section; and
a peripheral section that surrounds the central section while having a step bordering the central section, wherein
a part of the central section on a side bordering on the peripheral section is formed to be an inclined surface, and each of a starting point and an endpoint of the inclined surface is formed to be a curved surface, and
the cover member has a coated surface.

2. The cover member according to claim 1, further comprising a marking for recognizing a position of the inclined surface.

3. A lens unit comprising:
an image forming lens that forms an image based on subject light; and
a cover member disposed in front of the image forming lens, wherein
the cover member includes:
a central section; and
a peripheral section that surrounds the central section while having a step bordering the central section, wherein
a part of the central section on a side bordering on the peripheral section is formed to be an inclined surface, and each of a starting point and an end point of the inclined surface is formed to be a curved surface, and
the cover member has a coated surface.

4. A production method of a cover member to be disposed in front of an optical component, the production method comprising:
forming a cover member base that has a central section and a peripheral section that surrounds the central section while having a step bordering the central section, in which a part of the central section on a side bordering on the peripheral section is formed to be an inclined surface, and each of a starting point and an end point of the inclined surface is formed to be a curved surface; and
coating the cover member base with a film-shaped coating material, by soaking the cover member base in a posture in which the inclined surface is directed downward in the coating material in liquid form, and raising the cover member base from the coating material thereby making the coating material adhering to the cover member base solidify.

5. The production method according to claim 4, wherein
the forming the cover member base is forming the cover member base that further includes, in addition to the central section, the peripheral section and the inclined surface, a coating-material pool section which is disposed at a position lower than the inclined surface across the peripheral section when the inclined surface is directed downward, and which guides the coating material streaming down the inclined surface and the peripheral section further downward thereby accumulating the coating material, and
the production method further comprises the removing the coating-material pool section after the coating.

6. The production method according to claim 5, wherein the removing is removing the coating-material pool section while leaving a piece of the coating-material pool section on the cover member base, thereby forming a marking formed by the piece and used to recognize the inclined surface.
